(19) United States
(12) Patent Application Publication
(10) Pub. No.: US 2026/0146757 A1
(43) Pub. Date: May 28, 2026

(54) PARTITIONED HVAC CONTROLLER

(71) Applicant: BELIMO Holding AG, Hinwil (CH)

(72) Inventors: Juergen Martin, Zurich (CH); Theodor Scheidegger, Schaenis (CH); Andri Toggenburger, Zurich (CH); Volkher Scholz, Zurich City (CH); Pascal Hertrich, Zurich City (CH)

(21) Appl. No.: 18/957,347

(22) Filed: Nov. 22, 2024

(51) Int. Cl. F24F 11/65; F24F 11/58

(52) U.S. Cl. CPC F24F 11/65; F24F 11/58

(57) ABSTRACT

In some aspects, the HVAC field device described herein includes: a housing; an HVAC functional device; a non-volatile memory unit including: a first set of computer-executable instructions in a first memory partition configured to execute an operating system; and a second set of computer-executable instructions in a second memory partition configured to execute an application module, wherein the application module is configured to control operation of the HVAC functional device; a volatile memory unit; and at least one processor configured to: execute the operating system in a first memory region of the volatile memory unit and execute the application module in a second memory region of the volatile memory unit, wherein the application module is prevented from accessing the first memory region of the volatile memory unit.

### BACKGROUND

### Technical Field

The present disclosure relates to the operation and control of a Heating, Ventilation and Air Conditioning (“HVAC”) field device. The HVAC field device can include an HVAC base block and an HVAC add-on block.

### Background

With the increasing complexity of HVAC systems, there is an ever-increasing demand for a wide variety of field devices implementing various electrical, mechanical, thermal, and/or other functions (e.g., hydraulic, optical). Covering such a wide range of functions, and being suitable for a wide range of environments, results in a very high number of HVAC field devices and control systems. Additionally, even for the same HVAC field devices, there are a wide array of use cases.

Each HVAC field device, and sometimes each use case, can require the use of different control software that needs to be installed and configured. Each configuration can be characterized by different operating conditions and different operational parameters. It can be difficult to have control software that is customized to each hardware configuration and use case. Satisfying such demand for control software for a wide range of HVAC field devices is complex and difficult to maintain.

After the initial configuration, the control software of the HVAC field devices may need to be updated and/or replaced in the field. It can be a difficult and arduous process to update and/or modify existing HVAC field devices that are installed in the field. Additionally, updating the field devices may require shutting down the HVAC system for a time period in order to perform the updates.

### SUMMARY

The systems, methods, and devices of this disclosure each have several innovative aspects, no single one of which is solely responsible for all of the desirable attributes disclosed herein.

It is an object of embodiments disclosed herein to provide an HVAC field device including an HVAC add-on block and an HVAC base block, a method of operating an HVAC field device and computer program product(s) for the HVAC add-on block and/or the HVAC base block that overcome one or more of the disadvantages of the prior art. According to the present disclosure, this object is achieved by the features of the independent claims. In addition, further advantageous embodiments follow from the dependent claims and the description.

It is to be understood that detailed descriptions of embodiments are intended to provide an overview or framework for understanding the nature and character of the disclosure. The accompanying drawings are included to provide a further understanding and are incorporated into and constitute a part of this specification. The drawings illustrate various embodiments, and together with the description serve to explain the principles and operation of the concepts disclosed.

Although certain embodiments and examples are disclosed herein, inventive subject matter extends beyond the examples in the specifically disclosed embodiments to other alternative embodiments and/or uses, and to modifications and equivalents thereof.

### BRIEF DESCRIPTION OF THE DRAWINGS

Where reference numbers are re-used, correspondence between referenced elements is indicated. The drawings are provided to illustrate embodiments of the subject matter described herein and not to limit the scope thereof.

FIG. 1 illustrates a schematic block diagram of an HVAC system comprising an HVAC field device according to the present disclosure.

FIG. 2 illustrates a schematic block diagram of an HVAC field device including an HVAC base block and an HVAC add-on block according to the present disclosure.

FIG. 3 illustrates a schematic block diagram of operation of an HVAC field device including an HVAC base block and an HVAC add-on block according to the present disclosure.

FIG. 4 illustrates a schematic block diagram of an embodiment of a memory unit of an HVAC add-on block according to the present disclosure.

FIG. 5A illustrates a schematic block diagram of communication between components of the HVAC field device according to the present disclosure.

FIG. 5B provides a schematic diagram of stand-alone and external control operational modes.

FIG. 6A provides a schematic diagram of a process for updating an application module during operation of the HVAC field device.

FIG. 6B provides a schematic diagram of a process for restoring an application module after an application fault during operation of the HVAC field device.

FIG. 6C provides a schematic diagram of a process for updating a firmware module or a core module during operation of the HVAC field device.

FIG. 7 illustrates a flow chart depicting steps of a method of operating an HVAC field device according to the present disclosure.

FIG. 8 illustrates a flow chart depicting steps of a method of updating an application module for an HVAC field device according to the present disclosure.

FIG. 9 illustrates a flow chart depicting steps of a method of recovering from a fault of a control application for an HVAC field device according to the present disclosure.

FIG. 10 illustrates a flow chart depicting steps of a method of updating a firmware module or a core module during operation of an HVAC field device according to the present disclosure.

### DETAILED DESCRIPTION

### HVAC System Overview

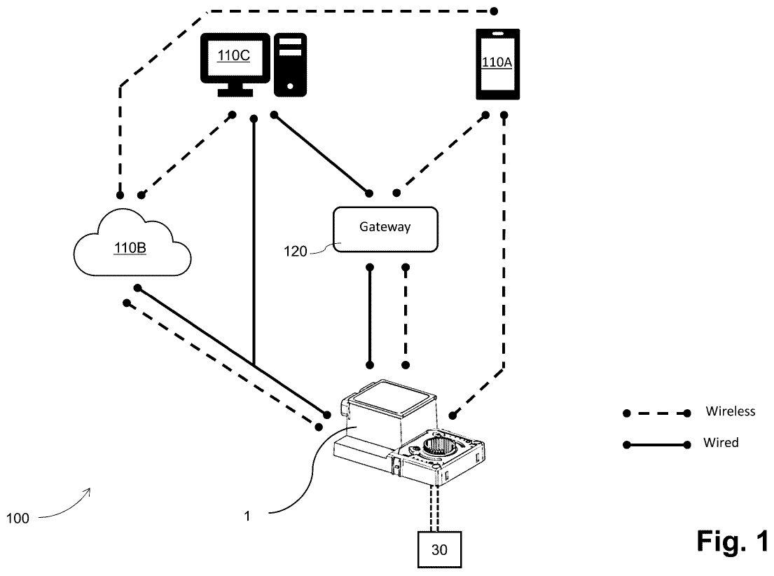

FIG. 1 illustrates an embodiment of an HVAC system 100. The system includes an HVAC field device 1 according to the present disclosure. The HVAC system 100 comprises one or more external computing devices 110A, 110B, 110C that can be communicatively connected to the HVAC field device 1 via a communication network. The network can include any type of communication network, such as a remote server 110B communicatively connected with the HVAC field device 1 using a wired or wireless network. Additionally, or alternatively, the HVAC field device 1 is configured to establish a communication link with a mobile computing device 110A using one or more wireless communication networks, such as radio communication circuits, in particular a Near Field Communication NFC, a Bluetooth® Low Energy BLE and/or a Wireless Local Area Network WLAN communication circuit. The HVAC field device 1 is further connectable to a control terminal 110C, such as a computing device running a Building Management System (BMS), either directly or via a gateway device 120 using a wired (such as a BUS connection) or a wireless connection (such as WLAN).

The HVAC field device 1 is hydraulically and/or mechanically connectable to at least part of fluid transportation circuit(s) with fluid supply/return lines, such as pipes, ducts or ports of valves and/or dampers such as to regulate and/or measure parameters of fluid(s) flowing therethrough. The parameters may include flow rate, temperature, humidity, pressure, viscosity, chemical composition, and/or other parameters. Alternatively, or additionally, the HVAC field device 1 is connectable to other HVAC field device(s) such as to control and/or measure parameters thereof, such as valve position and speed, current and voltage of actuator(s), positions of flow regulating devices (such as valves and/or dampers), and/or other parameters associated with the operation of HVAC field device(s).

The HVAC field device 1 can include one or more HVAC controller(s) (not shown in FIG. 1) configured to interface with an HVAC functional device 30, such as generating control signal(s) for operating HVAC actuator(s) and/or processing signals from HVAC sensors. In typical HVAC applications, the HVAC controller(s) generate the control signals for the HVAC actuator(s) according to various control algorithms (e.g., with regards to differential pressure, room temperature, flow of energy, etc.) to actuate the HVAC actuator(s), such as to open and close an orifice of a valve or damper to regulate the flow of fluid.

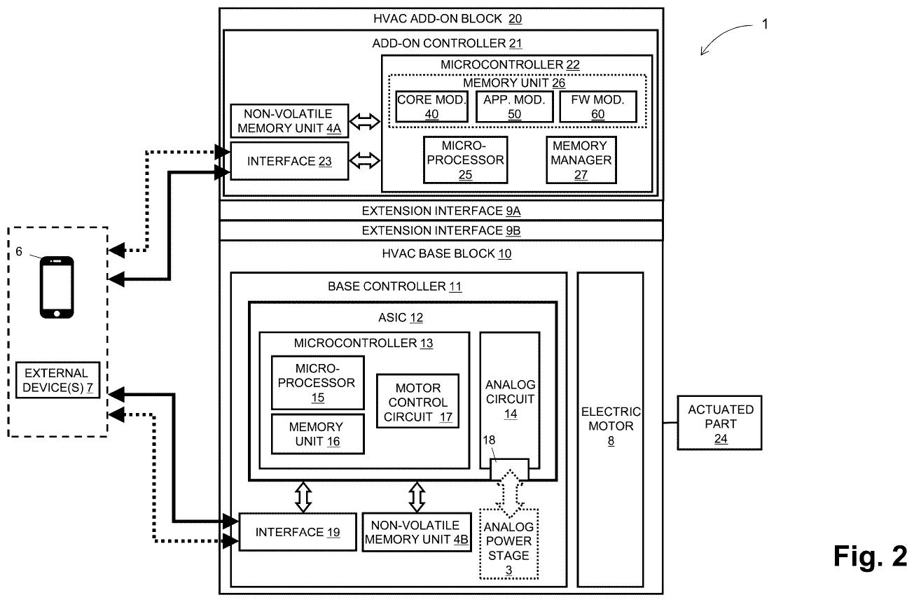

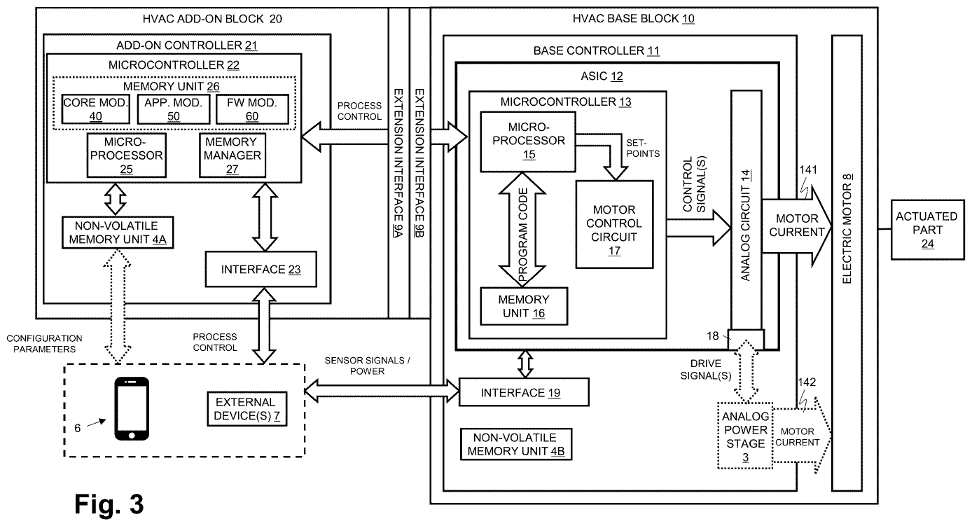

In order to address the need to provide a wide range of HVAC devices in a large number of different configurations without having to manufacture a specific type of HVAC field device 1 for each possible combination of functions and/or parameters, HVAC field device 1 can be assembled from multiple HVAC device blocks, with each HVAC device block fulfilling one or more HVAC functions. The HVAC field device 1 can include an HVAC base block 10 and an HVAC add-on block 20 as illustrated in FIGS. 2 and 3 and later described with respect thereto. The HVAC base block 10 can include the HVAC functional device 30, such as an actuator or a sensor.

Certain control functions of HVAC systems may be performed from a remote server arranged remotely from the HVAC field devices 1, the remote server can include an HVAC control system, such as a Building Management System (BMS), a Building Automation Systems (BAS) or other deployed system, to control and monitor a building's mechanical and electrical equipment. The HVAC control system can be provided according to one or more embodiments of systems, methods, computer program products, and related business methods for controlling one or more HVAC systems. The HVAC control system can be configured to provide HVAC control functionality. The term “HVAC control system” is used herein to represent a control system that is external to the HVAC field device 1 and can control a plurality of HVAC field devices within a building unit. The HVAC control system can have control functionality over measurable characteristics other than temperature (e.g., pressure, flow rate, power, etc.) for any of a variety of different control systems involving the governance of one or more measurable characteristics of one or more physical systems, and/or the governance of other energy or resource consuming systems such as water usage systems, air usage systems, systems involving the usage of other natural resources, and systems involving the usage of various other forms of energy. Each HVAC control system can include associated software that is executable to provide a user-interface component that can be used to control and monitor operation of the building unit. For example, the HVAC control system can provide for a user to identify a setpoint temperature value for a desired temperature.

Certain functions, in particular the commissioning and/or configuration of HVAC field devices may be performed by means of portable devices, such as a general-purpose mobile computing device (e.g., 110A) or a dedicated configuration tool.

### HVAC Field Device

Turning now to FIGS. 2 and 3, the HVAC field device 1 according to the present disclosure shall be described in further detail. As illustrated, the HVAC field device 1 is assembled by coupling a housing of the HVAC add-on block 20 to a housing of the HVAC base block 10 using extension interfaces 9A, 9B such that the HVAC add-on block 20 is mechanically and electrically connected with the HVAC base block 10 for transmission of electrical power and data signal(s).

### Extension Interface(s)

The extension interface(s) 9A, 9B refer to one or more counterpart interfaces of the HVAC add-on block 20 and the HVAC base block 10, respectively. The extension interface 9A can be arranged on or within the housing of the HVAC add-on block 20 (e.g., on or at least partially protruding from an external surface of the housing, or retracted inside the housing). The extension interface 9B can be arranged on or within the housing of the HVAC base block 10 (e.g., on or at least partially protruding from an external surface of the housing, or retracted inside the housing). The extension interface 9B of the HVAC base block 10 is provided to couple with the counterpart extension interface 9A of the HVAC add-on block 20. The extension interface(s) 9A, 9B can be configured for the transmission of both electrical power and data signal(s). The extension interfaces 9A, 9B of the HVAC base block 10 and HVAC add-on block 20 can include signal connectors for the transmission of electrical signals and power connectors for the transmission of electrical power. The HVAC field device 1 is assembled by coupling the HVAC add-on block 20 and the HVAC base block 10, such that the corresponding extension interfaces are electrically connected for transmission of electrical power and data signal(s). The electrical connections enable data communication between the HVAC base block 10 and the HVAC add-on block 20.

The HVAC base block 10 and HVAC add-on block 20 are configured for bidirectional transmission of digital signals through the extension interfaces 9A, 9B, in particular using a synchronous serial communication interface, such as an I²C, an SPI, an UART, a TWI interface and/or other interface. The extension interfaces 9A, 9B enable the HVAC add-on block 20 to be attached to the HVAC base block 10 and configured for digital communication, in particular digital transmission of raw sensor signals generated by the sensor of the HVAC base block 10, and/or digital representations of actuator control signals for driving the actuator of the HVAC base block 10.

### HVAC Base Block Overview

The HVAC base block 10 has a housing and can include a base controller 11 and a functional device, such as an actuator. Alternatively, or additionally the HVAC base block 10 can include a sensor. In the illustrated embodiment, the HVAC base block 10 is an actuator that includes an electric motor 8 for actuating an actuated part 24. In an embodiment, the electric motor 8 can be a brushless permanent-magnet motor, such as a brushless direct current motor (BLDC). The HVAC base block 10 is configured to actuate the actuated part 24 in the HVAC system 100 that is located outside the housing. For example, the actuated part 24 can be a valve or a damper for adjusting the flow of fluid in a pipe or duct of the HVAC system 100.

The base controller 11 can be configured to control operation of the electric motor 8. The controller 11 includes an application specific integrated circuit (ASIC) 12, which includes a microcontroller 13 and an analog circuit 14.

### Microcontroller

The microcontroller 13 is configured to generate control signals for controlling the analog circuit 14. As illustrated, the microcontroller 13 comprises a microprocessor 15, a memory unit 16, and a motor control circuit 17. The memory unit 16 has stored therein program code configured to control the microprocessor 15. The program code constitutes the firmware for the ASIC 12 or base controller 11. The microprocessor 15 can be configured to direct the motor control circuit 17. In other words, the program code stored in the memory unit 16 controls the microprocessor 15 to direct the motor control circuit 17. As further described herein, the control of the motor control circuit 17 can additionally be based on process control data received from an add-on controller 21.

The microprocessor 15 can, for example, generate setpoint values for the motor control circuit 17. The setpoint values can depend on the selected/configured type of motor control. More specifically, depending on whether position control, speed control, or torque control is selected/configured as the motor control type, the microprocessor 15 generates for the motor control circuit 17 setpoint values for position, speed, or torque. The microprocessor 15 further provides to the motor control circuit 17 limit values, depending on the selected/configured type of motor control, for example power limit, speed limit and/or torque limit for position control, or power limit and/or speed limit for torque control. Additionally, the setpoint values can be based on process control data received from the add-on controller 21.

Depending on the selected/configured type of motor control, the motor control circuit 17 operates as a position controller, a speed controller, or a torque controller, using the respective setpoints and limits from the microprocessor 15. The motor control circuit 17 controls position, speed, or torque by generating the control signals for the analog circuit 14, using three-phase pulse width modulation (PWM). The motor control circuit 17 further provides feedback to the microprocessor 15 regarding current position, speed, and/or torque of the electric motor 8. While the microprocessor 15 executes a sequence of supervisory functions or steps at a defined rate, such as, at a rate of several milliseconds, the motor control circuit 17 can perform time critical real-time functions, at a comparably higher speed, such as, at a rate of several microseconds. The motor control circuit 17 can be further configured to implement different selectable/configurable types of motor controllers, such as, for example, a motor controller using sensor-less position detection, a motor controller using hall sensors for position detection, a motor controller using a potentiometer for position detection, and/or other types of motor controllers. The motor control circuit 17 generates the control signals for the analog circuit 14. The motor control circuit 17 is configured to implement different selectable/configurable types of motor control, e.g., position control, speed control, and/or torque control.

The microprocessor 15 of the ASIC 12 obtains and is controlled by program code stored in the memory unit 16 of the ASIC 12. The microprocessor 15 can receive process control data, such as configuration parameters, from HVAC add-on block 20. For example, the add-on controller 21 can receive the configuration parameters from a non-volatile memory unit 4A or 4B. The add-on controller 21 can set an operating mode of the microcontroller 13, respectively the microprocessor 15, and operate the electric motor 8 based on the configuration parameters. In some embodiments, the microprocessor 15 can obtain data and signal values via interface(s) 19, 23 from external device(s) 7, such as, for example, temperature values from a temperature sensor, flow rate values from a flow sensor, pressure values from a pressure sensor, synchronization data and/or other types of signals.

As described above, the microprocessor 15 can provide setpoints for the motor control circuit 17. The setpoints may additionally be based, at least in part, on data and signal values from external device(s) 7 and the HVAC add-on block 20. The microprocessor 15 may receive the setpoints from a microcontroller 22 of the HVAC add-on block 20. The motor control circuit 17 can generate control signals for the analog circuit 14 and/or drive (control) signals for an analog power stage 3. Responsive to the control signals or drive signals from the motor control circuit 17, the analog circuit 14 or the analog power stage 3, respectively, generate motor currents 141, 142 for the electric motor 8. In one configuration the base controller 11, including the ASIC 12, and the electric motor 8 are arranged on a common printed circuit board (PCB).

### Analog Circuit

The analog circuit 14 comprises a power stage circuit (not shown) configured to generate the motor current 141 for the electric motor 8. In one embodiment, the power stage circuit includes three half bridges for energizing three phases of the electric motor 8. The power stage can generate the phase currents for energizing phases (e.g., three phases) of the electric motor 8. For example, the power stage circuit is configured to energize the phases by way of pulse width modulation (PWM) in a sinusoidal manner. In an embodiment, the analog circuit 14 generates an identification signal for indicating to the microcontroller 13 the version or power level of the analog circuit 14, such as, 200 mA of maximum current or 600 mA of maximum current. Thereby, the same microcontroller 13 may be used for different builds of the analog circuit 14.

### Analog Power Stage

As indicated schematically by dashed lines, the ASIC 12 can be configured to be combined with an external analog power stage circuit 3 in cases where the built-in power stage of the analog circuit 14 does not provide sufficient power for the electric motor 8 being used. For these cases, the analog circuit 14 of the ASIC 12 can include output terminals 18 and can be configured to provide drive (control) signals to an external analog power stage circuit 3 connected to the output terminals 18. The external analog power stage circuit 3 can be configured to generate the motor current 142 for the electric motor 8. In one embodiment described herein in connection with analog circuit 14, the external analog power stage circuit 3 includes three half bridges for energizing the three phases of the electric motor 8. It should be noted that in cases where, the built-in power stage of the ASIC 12 is used, the output terminals 18 can be configured and used as digital output terminals for outputting other values or signals from the ASIC 12 or the microcontroller 13. For example, the output of a charge pump controller (integrated in the ASIC 12) can be directed to the output terminals 18.

### HVAC Add-On Block Overview

The HVAC add-on block 20 includes a housing (not shown) and an extension interface 9A that is configured such as to be mechanically attachable and electrically connectable to the HVAC base block 10. The HVAC add-on block 20 includes an add-on controller 21, which includes a microcontroller 22, non-volatile memory unit 4A, and an interface 23.

### Interface

The interfaces 19, 23 can be configured for wired and/or wireless communication with one or more external devices 7 and/or external communication devices 6. The interfaces 19, 23 can be a wired communication interface-s-and/or radio communication devices-. In particular, the interfaces 19, 23 comprise one or more of: a wired communication interface (such as an Ethernet, in particular a Power over Ethernet PoE, Single Pair Ethernet SPE, a BUS, in particular an MP Bus, BACnet, KNX or Modbus interface); a Wide Area Network WAN communication circuit (such as GSM, LTE, 3G, 4G or 5G mobile communications circuit); a Low Power Wide Area Network (such as Narrowband Internet of Things NB-IoT, Long Range LoRa/LoRaWAN, SigFox, or Long Term Evolution Category M1 LTECatM1); a Local Area Network LAN communication circuit (such as Wireless LAN); a short-range wireless communication circuit (such as Bluetooth®, Bluetooth® low energy BLE®, Ultra-wideband UWB, Thread and/or Zigbee); and/or a close-range wireless communication circuit (such as a Radio Frequency Identification RFID or a Near Field Communication NFC).

In some embodiments, the add-on controller 21 can include the non-volatile memory unit 4A connected to interface 23, which can include a wireless communication interface, such as, a Near Field Communication (NFC) circuit. The non-volatile memory unit can be, for example, an Electrically Erasable Programmable Read-Only Memory (EEPROM). In these embodiments, an external communication device 6, such as a mobile phone, a smart watch, or a tablet or laptop computer, can access the non-volatile memory unit 4A via the interface 23. Particularly, the external communication device 6 can read and write configuration parameters from and to the non-volatile memory unit 4A. The non-volatile memory unit 4A can be configured to store configuration parameters for the HVAC field device 1 and its controller(s), i.e., base controller 11 and/or add-on controller 21.

The person skilled in the art will understand that other communication interfaces, particularly wired communication interfaces and/or communication buses, can also be provided and used to access the non-volatile memory unit 4A. In some embodiments, the non-volatile memory unit 4A and/or the interface 23, such as, an NFC circuit, can be integrated into the microcontroller 22. Alternatively, the interface 23 can be connected via an I²C (serial) interface. In some embodiments, the HVAC base block 10 can include the interface 19 connected to the non-volatile memory unit 4B. These components may include the same or different types of interfaces. The interface 19 can be connected to the non-volatile memory unit 4B and may be disabled when the HVAC add-on block 20 is coupled to the HVAC base block 10.

The attachment of the HVAC add-on block 20 to the HVAC base block 10 enables processing of data signal(s) according to communication protocols not supported by the electronic circuit of the HVAC base block 10. For example, the electronic circuit of the HVAC base block 10 may only support analog and a subset of digital communication protocols, such as MP-Bus Slave, while the electronic circuit of the HVAC add-on block 20 can be configured to further support a larger set of digital and analog communication protocols, such as, RS485, KNX, MP-Bus, I²C, etc. The addition of the HVAC add-on block 20 can enable integration of the HVAC field device 1 into HVAC systems 100 that use bus communication protocols, such as MP Bus, BACnet, KNX or Modbus.

Additionally, the interfaces 19, 23 can be configured to connect the base controller 11 and/or the add-on controller 21 to external devices 7 arranged externally to the HVAC field device 1. The interfaces 19, 23 can include digital interfaces and/or analog interfaces configured for communication with the external devices 7. For example, the digital interfaces can include a serial communication line interface, e.g. a serial port interface (SPI), a parallel communication bus interface, or other digital interfaces. The analog interfaces can include analog input terminals for receiving analog input signals (such as, for example, setpoint signals, potentiometer signals for position control, analog sensor signals (e.g., temperature sensor signals)), analog output terminals for providing analog output signals (such as, for example, providing analog feedback signals to a superior control system) and/or other analog interfaces.

Interfaces 19, 23 can be configured to receive external setpoint values for the HVAC field device 1, such as, from a user terminal or an HVAC control system. In an embodiment, interfaces 19, 23 comprises a serial MP-bus slave interface configured to receive MP commands and transmit MP responses, and activate/deactivate the MP bus watchdog. In a further embodiment, interface 23 is configured to perform as a MP master gateway, receiving and forwarding master signals from an MP bus.

Examples of external devices include, but are not limited to, sensor devices (e.g., temperature sensors, flow sensors, pressure sensors, hall sensors, and/or other sensors), a supercap module, and/or other external devices. A sensor device can be configured to measure a parameter of the HVAC system 100, in particular an environmental parameter, such as a temperature, humidity, particulate matter PM, CO2 level of an environment controlled by the HVAC system 100, and/or other parameters of the HVAC system 100. Alternatively, or additionally, the sensor of the HVAC base block 10 can measure operational parameters of various components of the HVAC field device 1 or the HVAC system 100 such as an actuated position of the actuated part 24 and/or the operational state of the HVAC field device 1 and/or other parameters of the HVAC system 100, such as a flow rate or differential pressure at locations of a liquid through a fluid transportation system. The microprocessor 25 or the program code, respectively, is configured to exchange data between a memory unit 26 and other external device(s) 7, via the interface 23. The microprocessor 15 or the program code, respectively, is configured to exchange data between the memory unit 16 and external device(s) 7, via the interface 19.

### Add-On Controller

The add-on controller 21 is configured to extend the functionality of the HVAC base block 10. In particular, the microcontroller 22 can provide data signal processing capabilities not supported by the base controller 11 of the HVAC base block 10. The add-on controller 21 comprises a microcontroller 22 with a processing unit, such as microprocessor 25 or, in some embodiments, an application specific integrated circuit (ASIC) for providing computing power to the HVAC field device 1. The add-on controller 21 is controlled based on computer-executable instructions of a firmware module 60, a core module 40 and an application module 50 stored in the memory unit 26.

The microcontroller 22 can be (pre)configured for application-specific extension of the functionality of the HVAC base block 10, such as for executing a program code stored in the memory unit 26 of at least a plurality of software modules including a core module 40, an application module 50, and a firmware module 60. The firmware module 60 provides for supervision of critical functionality of the add-on controller 21. The core module 40 includes the operating system functionality (e.g., real-time operating system (RTOS), drivers, network stacks, etc.). The application module 50 includes application logic for the functional devices of the HVAC base block 10 (e.g., actuators, sensors, etc.) The application module 50 can include a specific HVAC application, such as Variable Air Volume VAV control based on data signals from a sensor for the measurement of an air flow. The microcontroller 22 can be provided with and/or retrieve computer-executable instructions, such as a binary, for the application module 50 from external computing device 6 via the interface 23 of the HVAC add-on block 20 or the interface 19 of the HVAC base block 10, such as a mobile computing device, and/or from external device(s) 7, such as a remote server or an HVAC control system.

### Memory Unit/Memory Manager

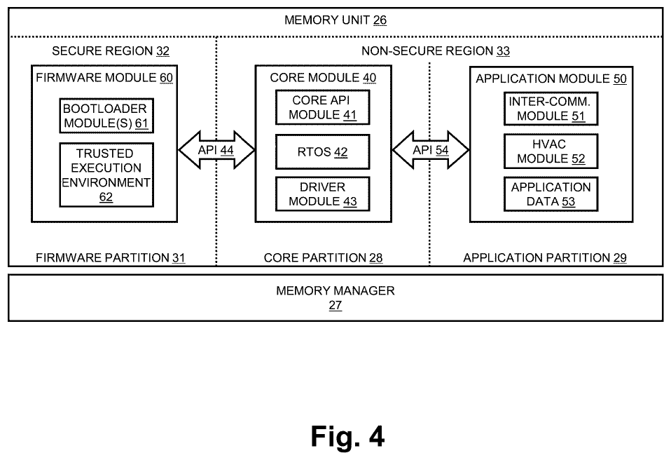

The memory unit 26 and a memory manager 27 are described with further reference to FIG. 4. The memory unit 26 can include partitioned volatile and non-volatile memory. The memory unit 26 can include flash memory serving as non-volatile memory for the firmware module 60, the core module 40, and the application module 50. The firmware module 60, the core module 40, and the application module 50 can be separate executables that are assigned different and non-overlapping portions of the memory unit 26, such as a firmware partition 31, a core partition 28, and an application partition 29. The memory unit 26 also includes volatile memory, such as Random Access Memory (RAM), which can be partitioned for execution of the firmware module 60, the core module 40, and the application module 50. The memory unit 26 can be divided between a secure memory area 32 and a non-secure memory area 33. The firmware module 60 can execute in the secure memory region 32, and the core module 40 and the application module 50 can execute in the non-secure memory region 33. The division between the firmware module 60, the core module 40 and the application module 50 can provide greater flexibility, stability, and security for the HVAC field device 1 compared to unsecured and non-partitioned implementations.

The memory manager 27 can be configured to manage the memory unit 26. The memory manager 27 can comprise hardware-based features and components and/or software-based features that can ensure the security and integrity of memory and data in the memory unit 26. The memory unit 26 can use a hardware-based approach for creating isolation between the secure memory region 32 and the non-secure memory region 33, such as Arm TrustZone, a memory management unit (MMU), and/or a memory protection unit (MPU). The secure memory region 32 can run the firmware module 60 while the core module 40, and the application module 50 are executed simultaneously within the non-secure memory region 33. The hardware isolation between the secure region 32 and the non-secure region 33 can extend beyond the memory unit 26 to encompass the microprocessor 25, bus transactions, interrupts and peripherals within the add-on controller 21.

The memory manager 27 can be used to ensure each executable binary does not access memory that has not been allocated to it. The memory manager 27 can be configured to dynamically partition memory for the core module 40 and the application module 50. The memory manager 27 can provide memory access control and isolation, preventing unauthorized or unintended access to certain memory regions by different software components or tasks running on the add-on controller 21.

In addition to the secure region 32 and the non-secure region 33, the memory manager 27 can define memory regions and divide the memory unit 26 into different segments. The memory manager can assign specific memory access permissions, such as the for the core module 40 and application module 50. These segments can be allocated for different tasks, processes, or software components, preventing one from accessing or modifying the memory of another. The memory manager 27 can allow for control over memory access permissions, such as read, write, and execute permissions, which can ensure that only authorized software components can access or modify specific memory regions. The memory manager 27 can enforce privilege levels so that only authorized tasks with the appropriate level of access can access certain memory regions. This can be particularly important in systems with different levels of software hierarchy, such as the core module 40 and applications module 50.

The memory manager 27 can prevent data corruption and unauthorized access by isolating data used by different tasks or processes. This can help to improve the security and reliability of the core module 40. If a task of the application module 50 attempts to access a memory region without the appropriate permissions, the memory manager 27 can trigger a memory protection fault, alerting the firmware module 60 and/or the core module 40 of the unauthorized access attempt.

The memory manager 27 can isolate the firmware module 60 from the core module 40 and the application module 50, and establish a trusted execution environment 62 in the secure memory region 32. Additionally, the core module 40 can be isolated from the application module 50 to ensure that that the real-time operating system (RTOS) 42 operates without potential interference or faults caused by the application module 50. This can help to prevent buffer overflows, unauthorized access, and other memory-related vulnerabilities, contributing to the overall robustness and reliability of the add-on controller 21.

### Firmware Module

The firmware module 60 includes one or more bootloader modules 61 and provides a secure operating environment referred to as a trusted execution environment 62.

### Bootloader Module

The bootloader module(s) 61 can be configured to execute a startup sequence that provides a root of trust for secure boot and secure firmware module update processes. The bootloader module(s) 61 can include one or more stages of bootloaders, such as a stage 1 and/or stage 2 bootloader. At least one of the bootloaders can be immutably stored in the memory unit 26. The secure boot process can verify secure boot images, which can be cryptographically authenticated, such as by using public and private keys. The bootloader module(s) 61 can manage the secure firmware update process. The secure firmware update process can update components of the firmware module 60, such as a mutable bootloader module. A failsafe mechanism can be used to rollback components of the firmware that fail or are unsuccessfully updated.

### Trusted Execution Environment

The secure boot process can be executed to provide a trusted execution environment 62, which is a secure operating system that provides a secure execution environment for the core module 40. Modules executing in the non-secure region 33 (e.g., core module 40 and application module 50) can be prevented from accessing the secure region 32, regardless of privilege level. The trusted execution environment 62 provides an interface between the secure region 32 and non-secure region 33.

The trusted execution environment 62 can authenticate and start execution of the core module 40. For example, the trusted execution environment 62 can verify the signature of the core module 40 prior to execution. The trusted execution environment 62 can update the core module 40 during operation. The trusted execution environment 62 can provide a failsafe mechanism to rollback the core module 40 to a previous version if the update is unsuccessful of if there is a fault. The trusted execution environment 62 can manage and implement secure storage processes. The trusted execution environment 62 can communicate with the core module 40 via a secure API 44.

### Core Module

The components of the core module 40 can include a core application programming interface (API) module 41, a real-time operating system (RTOS) 42, and a driver module 43.

### Core API Module

The core API module 41 is configured to provide a communication interface for the core module 40 to communicate with the firmware module 60 and to communicate with the application module 50. The core module 40 can communicate with the firmware module 60 using a secure API 44. The secure API can be configured to allow communication between the secure memory region 32 and the non-secure memory region 33. The core module 40 can communicate with the application module 50 using an inter-thread API 54. The inter-thread API 54 can be a set of functions and protocols that allows multiple threads within the application module 50 to communicate and coordinate their actions with the core module 40. In a multithreaded application, the inter-thread API 54 can facilitate the exchange of data, synchronization of tasks, and management of resources between different threads.

These APIs can enable threads to work together, share information, and achieve concurrency in a coordinated manner. The core API module 41 can provide a methodology and process for controlled communication between the core module 40, the firmware module 60, and the application module 50, which can help provide a secure operating environment, protect against potentially malicious applications, and increase stability.

### Real-Time Operating System

The real-time operating system (RTOS) 42 can be a secure operating environment that is extensively tested. The RTOS 42 can utilize ARM® TFM regions and hardware encryption. Security relevant features such as key handling, encryption and decryption are handled by the RTOS 42 and can be configured to not be directly accessible by the application module 50.

The RTOS 42 is configured to handle communication in and out of the HVAC field device 1, such as via interface 19, 23. The RTOS 42 can also handle communication within the HVAC field device 1, such as between the base controller 11 and the add-on controller 21 via extension interfaces 9A, 9B. Any communication that is received by the HVAC field device 1 can be provided as necessary to the application module 50 to determine how to control the functional component (e.g., an actuator) of the HVAC field device 1. For example, the RTOS 42 can receive communication from an external source (e.g., an HVAC control system) that identifies setpoints for controlling the actuator. The setpoints can be communicated via the core module 40 to the application module 50.

The RTOS 42 executes independently of the application module 50. The RTOS 42 can control execution of the application module 50. For example, the RTOS 42 can start, shutdown, restart, update, remove, install, and/or otherwise control operation of the application module 50. As such, the RTOS 42 can continue operating while the application module 50 is being updated and/or changed. This can help to facilitate a software update, installation, or removal process. For example, the RTOS 42 can delete and replace the application module 50, allowing for a change of the HVAC functionality of a deployed HVAC field device 1. The RTOS 42 can also continue operating if there is a fault detected in the application module 50. For example, if a fault causes the application module 50 to unexpectantly quit or become otherwise compromised, the RTOS 42 can continue to operate and provide process control instructions to the base controller 11 of the HVAC base block 10. For example, in such an instance, the RTOS may instruct the base controller 11 to control the actuator based on operational parameters stored in memory unit 16. Additionally, the core module 40 can provide system security to help prevent an application module 50 from adversely affecting processes of the core module 40.

### Driver Module

The driver module 43 is responsible for drivers configured to handle the physical layer of the add-on block 20, such as microprocessor 25, the memory unit 26, interface(s) 19, 23, extension interfaces 9A, 9B, physical elements of the add-on block (e.g., LEDs, buttons, etc.), and/or other drivers configured to control functionality and communication components of the add-on block 20.

### Application Module

The application module 50 can be configured to control operation of the HVAC functional device 30, such as a sensor or actuator. The application module 50 can be a separate binary that executes in its own thread(s) and the operation of the application module 50 can be isolated from the operation of the core module 40. The application module 50 can be partitioned such that it is prevented from accessing memory regions of the core module 40. The core module 40 and application module 50 can communicate via inter-thread API 54.

In some embodiments a second application module (not shown) isolated from the application module 50 may be provided. For instance, the second application module may be provided in a separate memory partition so that it does not interfere with the operation of the application module 50. In this way the application module 50 and the second application module can be executed independently from one another. The second application module can be used to support third-party applications, e.g., from an original equipment manufacturer (OEM). As with the application module 50, the second application module is prevented from accessing the core module 40. The second application module can also be prevented from accessing memory regions of the application module 50.

By separating the application module 50 and the core module 40, the application module 50 provides software modularity for the HVAC field device 1. The application can be changed and/or adapted to a specific HVAC field device 1 or a particular customer's needs. For example, a third party (e.g., a customer) may provide a customized application for use by the HVAC device without compromising the security and integrity of the core module 40. The application module 50 can be modified or replaced in the field based on communication received over a network by an HVAC control system, such as through interface(s) 19, 23. The application module 50 can fail or experience a fault without affecting operation of the core module 40. The application module 50 can be independently restarted, replaced, or repaired by the core module 40. In the rare case that the application module 50 is malicious, it cannot affect the operation of the core module 40, as it is not allowed to enter memory regions where the core module 40 resides.

The application module 50 can be specific to the operating environment of the HVAC field device 1 (e.g., a house, office building, apartment, etc.). As another example, the application module 50 may be specific to operating in winter or summer. Each application module 50 can be specifically adapted to the combination of the HVAC add-on block 20 and HVAC base block 10. The application module 50 can be specific to the physical HVAC capabilities of the HVAC base block 10, such as actuating or sensing capabilities. As the add-on block 20 and base block 10 can be produced independently and combined at the request of the customer, the application module 50 can be parameterized and installed at production time, at installation, or thereafter. Furthermore, the application can be updated and/or replaced at a subsequent time. The combination of the modular software of the HVAC module 52 and the modular hardware combination of the add-on block 20 and base block 10 can provide complete modularity for HVAC applications. The components of the application module 50 can include an inter-communication module 51, an HVAC module 52, and application data 53.

Using software partitioning with hardware modularity enhances flexibility, scalability, and maintainability across the entire HVAC system. The combination allows for quick customization of both HVAC hardware and HVAC software for new requirements and/or HVAC system environments. Furthermore, HVAC applications can scale dynamically with HVAC hardware changes without requiring deep software rewrites, i.e. to the operating system. It also ensures that both hardware and software upgrades remain cost-effective and minimally disruptive to the HVAC system. Additionally, HVAC applications can be ported across devices with differing hardware configurations, as long as the core module provides consistent APIs for the application module.

### Inter-Communication Module

The inter-communication module 51 can handle inter-thread communication with the core module 40. The inter-communication module 51 can be a broker that interacts through remote procedure calls and handles communication on behalf of the application. The inter-communication module 51 can send and receive messages using the inter-thread API 54. This can serve to prevent the application module 50 from accessing protected memory regions of the core partition 28.

### HVAC Module

The HVAC module 52 can be configured to control operation of the functional device of the HVAC base block 10. For example, the HVAC module 52 can be configured to control operation of a sensor and/or an actuator. Each HVAC module can provide functional control logic for the associated device and/or system. The HVAC module 52 is responsible for the HVAC logic and for data handling. For example, the HVAC module 52 can receive setpoints from the HVAC control system, such as a building management system (BMS), and use the setpoints to determine how the HVAC field device 1 will operate. The HVAC module 52 can include logic and control algorithms that can be configured to process operational data (e.g., from the HVAC base block 10) and/or external control data (e.g., setpoints from the HVAC control system) and generate process control data for controlling the functional device of the HVAC base block 10. The operational control outputs can be sent to the core module 40. The core module 40 can then communicate the outputs to the HVAC base block 10.

### Application Data

The application data 53 associated with operation of the HVAC field device 1 can be stored in the memory unit 26. The application data 53 can include data generated by the HVAC field device 1, such as sensor data and/or data received from external sources (e.g., a building management system), and the like. The application data can include operational data, configuration parameters, operational performance indicators, and/or other types of data that can used by the functional modules to determine operational control outputs. Different examples of data and some of their uses are described below.

### Configuration Parameters

### Motor Control

Configuration parameter(s) directed to the type of motor controller determines whether the motor control circuit 17 operates as a motor controller using sensor-less position detection, a motor controller using hall sensors for position detection, or a motor controller using a potentiometer for position detection. The sensor-less position detection can include back electromotive force (BEMF) position detection and rotor induction-based position detection, for example. The application module 50 operates in accordance with the selected/configured type of motor controller. The configuration parameter(s) directed to the type of motor control determines whether the motor control circuit 17 operates using position control, speed control, or torque control. The application module 50 operates in accordance with the selected/configured type of motor control.

### Control Loop

Configuration parameter(s) can be directed to the type of control loop and determines whether the application module 50 executes an air volume control, a differential pressure control, position control, temperature control, power control, or a flow rate control. The application module 50 processes received setpoints and data/signal values in accordance with the selected/configured type of control loop, e.g. as an air flow value, a differential pressure value, or a flow rate value, for example.

### Type of Actuator

Configuration parameter(s) can be directed to the type of actuator and determines whether the electric motor 8 is operated as a modulating actuator, an open-close actuator, or a three-point actuator, for example. The microprocessor 15 processes received setpoints and data/signal values in accordance with the selected/configured type of actuator.

### End-Stops

Configuration parameter(s) can be directed to the type of end-stops and determines how the application module 50, implements and processes a mechanical end-stop, a limit switch end-stop, a free wheel end-stop, a sensor end-stop, or a position counter end-stop. Depending on the selected/configured type of end-stop, the motor control circuit 17 determines and provides different feedback signals, which are processed by the application module 50. For example, for a mechanical end-stop, the feedback signals include rotation indicator and torque limit indicator; for a free wheel end-stop, the feedback signals include a free run indicator; for a sensor end-stop, the feedback signals include a sensor value; and for a position counter end-stop, the feed-back signals include a position or counter value.

### Operational Parameters

Configuration parameter(s) can be directed to the operation of the actuated part 24 or the electric motor 8 and other components. For example, the operational configuration parameter(s) include running speed, direction of rotation, communication interface address, input mode, analog input type, configuration of analog inputs and outputs for sensors and feedback, torque or force limit, end-stop positions, position control range, enable or disable auxiliary switches, switching positions of the auxiliary switches, position setpoints, fail safe positions, control mode, type of motor controller, linear or rotary actuator, position setting range, motor configuration parameters including torque limit, motor constant, number of pairs of poles, or inductivity, control parameters including controller gains for position, speed, current controller, allow a user to set input mode, enable storage of performance indicators, end-stop type, status of NFC communication, current microprocessor control mode indicating stand-alone mode or add-on control mode, operational parameter(s) for specific functions including tight closing of switching threshold, number of motor turns for gear release function, hand crank speed, spring return, speed ramp, or reduced speed close to end stops, or spring return actuator configuration parameters.

### Operational Performance Indicators

In addition to configuration parameter(s), the application module 50 is further configured to store operational performance indicators in the memory unit(s) 4A, 26. The operational performance indicators can be read by the external communication device 6 via interface(s) 19, 23, for example wirelessly via NFC. For example, the operational performance indicators relate to the performance of the electric motor 8. For example, the operational performance indicators include one or more of: total operating time, operating time in different temperatures ranges, minimum operating temperature, maximum operating temperature, maximum motor temperature, minimum operating voltage, maximum operating voltage, number of power failures, number of watchdog resets, number of motor start/stops, number of direction changes of motor, number movement onto mechanical end-stops, driving time versus torque histogram, maximum torque histogram for different position ranges, number of overload events, minimum and maximum end position displacements, supercap status, commissioning successful indicator, actuator has been powered in the field indicator, or actuator has been reconfigured in the field indicator.

### Operation of the HVAC Field Device

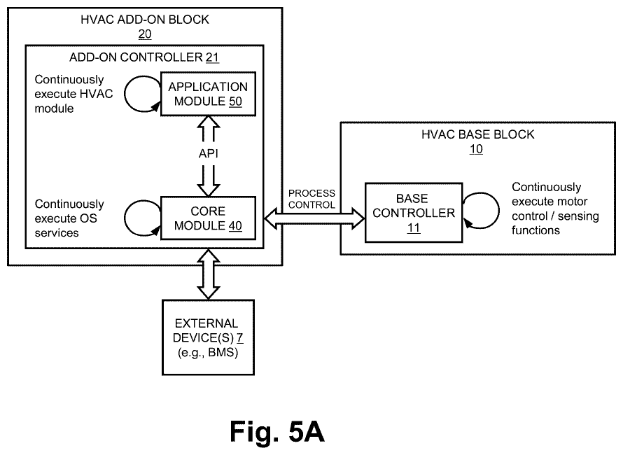

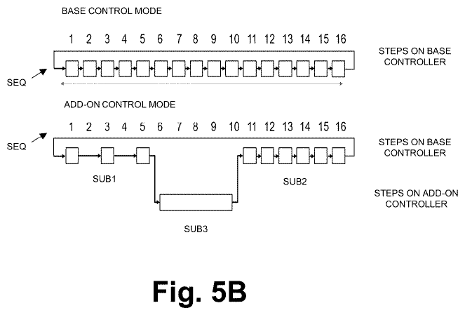

FIG. 5A is a block diagram illustrating an operation and a communication process of various components of the HVAC field device 1. As described above, the HVAC add-on block 20 includes the core module 40 and the application module 50. During operation of the HVAC field device 1, the core module 40 continuously executes the operating system services and the application module 50 continuously executes an HVAC module 52 configured to control operation of the functional device of the HVAC base block 10. In this manner, the execution of the HVAC module 52 is decoupled from the operation of the operating system. Additionally, the base controller 11 continuously executes the operation of the functional device of the HVAC base block 10 (e.g., motor control or sensing functionality).

The core module 40 can handle communication with the base controller 11 and external device(s) 7, such as an HVAC control system. The core module 40 can provide operational data received from the base controller 11 and data received from external device(s) to the application module 50. The application module 50 can process the incoming data and generate process control data for controlling the functional device. The application module 50 can communicate the process control data to the base controller 11 via the core module 40. More specifically, the add-on controller 21 can communicate the process control data to the base controller 11. The base controller 11 can use the process control data to execute the steps necessary to control the operation of the functional device.

FIG. 5B provides a schematic diagram of base control and add-on control operational modes. In base control mode, the base controller 11 controls operation of the HVAC functional device 30. An example of a control loop of the HVAC functional device 30 is illustrated by a state machine that repeatedly executes a fixed sequence of steps SEQ [1 2 3 4 5 6 7 8 9 10 11 12 13 14 15 16] implemented in the program code of the base controller 11.

When the HVAC field device 1 operates in an add-on control mode, the add-on controller 21 at least partially controls operation of the HVAC functional device 30. With reference to the control loop illustrated in lower part of FIG. 5B, one or more subsets (SUB1, SUB2) of these steps/tasks are executed by the base controller 11 and one or more subsets (SUB3) are executed by the add-on controller 21. The subsets of steps/tasks that are executed by the base controller 11 can be based on/determined by the one or more subsets (SUB3) that are executed by the add-on controller 21. More specifically, the base controller 11 does not execute the complete sequence SEQ of steps but the sequence can be split between the base controller 11 and add-on controller 21. In other words, some steps, e.g. subset SUB1, are performed by the base controller 11 while other (different) steps are performed by the application module 50 of the add-on controller 21. In the add-on control mode, a scheduler of the ASIC 12 may be deactivated and the add-on controller 21 can be in charge/control of the timing/scheduling. This can make it possible, for instance, to execute control loops, which require more processing power on the add-on controller 21. The base controller 11 and the add-on controller 21 can use a shared (common) data pool in a memory unit (e.g., memory unit 16 or 26) for exchanging data, for example, volatile memory of the microprocessor 15.

The example process described with reference to FIG. 5B can be modified as necessary based on the actual operational parameters of the system. In this example, the add-on controller 21 can execute steps/tasks in SUB3, which is the processing performed by the application module 50. The process control output generated by the application module 50 can define at least some of the steps for the base controller 11 to execute in subsets SUB1 and SUB2 (e.g., [1 3 5] and [11 12 13 14 15 16], respectively). The base controller can then execute subsets SUB1 and SUB2 of steps defined at least partially by the add-on controller 21. In this way, the add-on controller 21 and base controller 11 can control operation of the HVAC functional device within one control loop. In some embodiments, the fixed sequence of steps described with respect to the base control mode could be executed in the add-on control mode, but some of the steps are replaced by steps executed on the add-on controller 21.

Some examples of steps that can be executed by the base controller 11 can include: reading digital inputs; obtaining current operational values of the electric motor 8 (e.g., motor position, torque, actuator position); reading external setpoint values for an actuator; determining whether there is an exception situation (e.g., power failure, synchronization failure, gear problem, etc.); processing of controller input signals (e.g., inverting); processing of actuator functions (e.g., closing tightly, anti-sticking function, overload detection, breaking function, etc.); generating setpoint values for the motor control circuit 17; generating and outputting feedback signals (e.g., current motor position) via interface 19, such as, for a higher-level control system, such as a building control system; transfer of the setpoints to the motor control circuit 17; and/or outputting digital values.

If the application module 50 stops executing (e.g., because of an application fault, application update, etc.), the HVAC field device 1 can transition to a base control mode. The core module 40 can determine when to transition between control modes. For example, the core module 40 can instruct the base controller 11 to transition to the base control mode when a fault is detected. In the base control mode, the base controller 11 can execute repeatedly the fixed sequence of steps SEQ for generating the setpoints for the motor control circuit 17 that are stored in memory unit 16 and controlling operation of the actuated part 24. In the base control mode, a scheduler of the ASIC 12 is active and manages execution of the complete sequence SEQ of consecutive steps in a fixed order (e.g., with repetition every 100 ms).

### Application Module Update Process

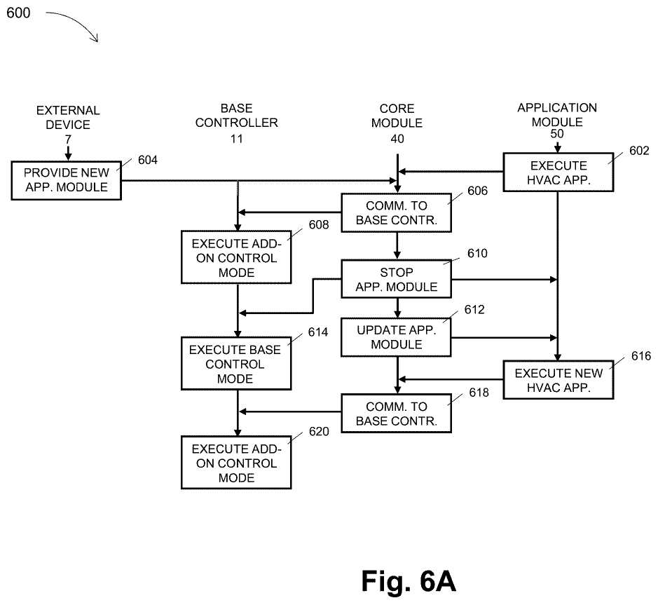

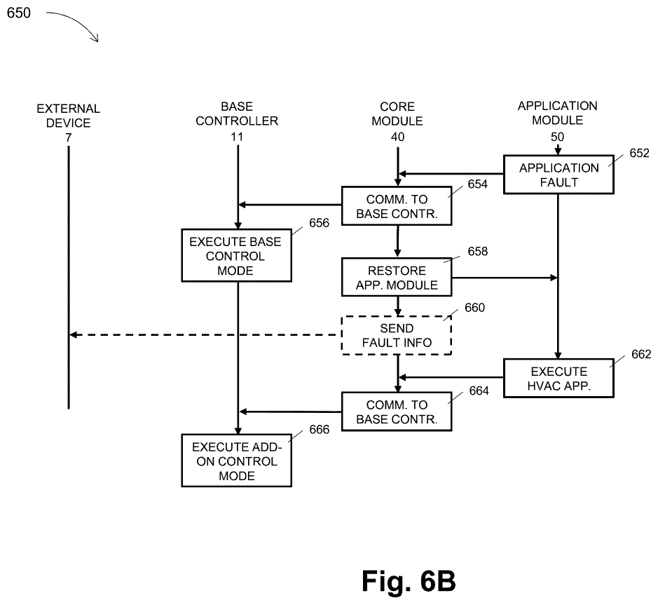

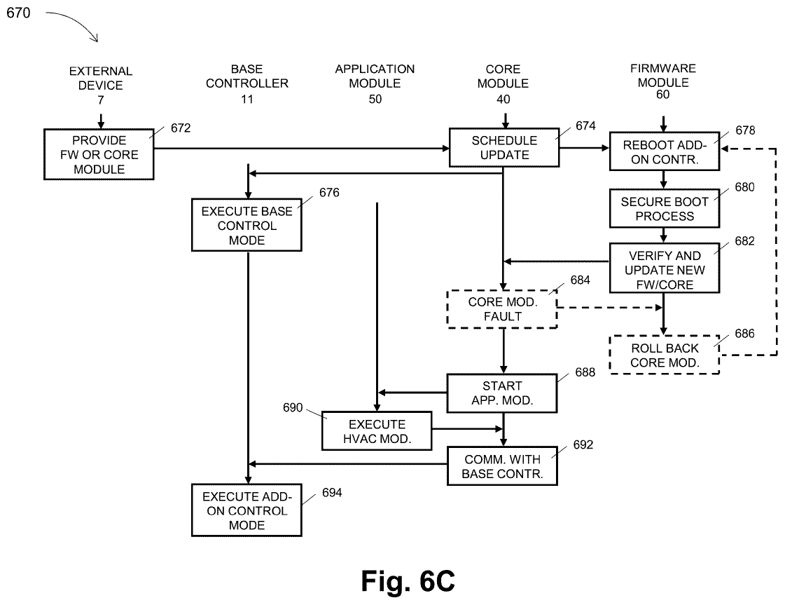

FIG. 6A depicts steps of a block diagram illustrating an embodiment of a process 600 of updating the application module 50 during operation of the HVAC field device 1.

At step 602, the application module 50 is executing the HVAC module 52 configured to control operation of the HVAC functional device 30 of the HVAC field device 1. The HVAC module 52 can generate process control data based on operational data received from the base controller 11 and data received from external devices 7 (e.g., a sensor or HVAC control system). The operational data and the process control data can be communicated between the application module 50 and the core module 40 via an inter-thread API 54.

At step 604, an external device 7 can provide a new application module 50 or an update to the existing application module 50 to the HVAC field device 1. The external device 7 that provides the new/updated application module can be an HVAC control system or other type of computing device (e.g., communication device 6). The new/updated application module can include updated operational algorithms configured to control the HVAC functional device 30. The application module 50 update can be communicated over a network, such as through communication interfaces 19, 23 of the base block 10 and add-on block 20, respectively.

At step 606, the core module 40 can continue to provide the process control data to the base controller 11 until it determines a time to update the application module 50. For example, the core module 40 may have a scheduled time for applying updates to the application module 50. In which case, at step 608, the base controller 11 can continue to execute in the add-on control mode.

At step 610, the core module 40 can stop execution of the application module 50 during operation. The core module 40 can suspend execution of the application module 50 without pausing operation of the core module 40. The core module 40 can also provide instructions to the base controller 11 to transition from the add-on control mode to the base control mode. In which case, at step 614, the base controller 11 can transition to the base control mode and execute control of the functional device 30. In the base control mode, the HVAC base block 10 can operate based on program code stored in the memory unit 16 of the base controller 11.

At step 612, the core module 40 can verify and update the application module 50. In some instances, the update can be a replacement of the application module 50. In some instances, the update may be an updated version of the application module 50. In some instances, the update can be to one or more configuration parameters. The update to the configuration parameter(s) may require that the application module 50 is reset or rebooted. The core module 40 can operate in a first partition, i.e., core partition 28 of the memory unit 26 on the HVAC add-on block 20 and the application module 50 can operate in a second partition, i.e., application partition 29 of the memory unit 26. The core module 40 can execute the update without affecting the operation of the core module 40. The update of the application module 50 can be confined to the second partition 29 within the memory unit 26. For example, the core module 40 can start, shutdown, restart, update, remove, install, and/or otherwise control operation of the application module 50 as necessary to implement the update process. The update and restart of the application module 50 can be completed without performing a power reset of the HVAC field device 1.

At step 616, the new/updated application module 50 can be executed and can resume control of the operation of the functional device of the HVAC field device 1 as described in step 602.

At step 618, the core module 40 can provide the process control data to the base controller 11 and can change the operation mode of the base controller 11 from the base control mode to the add-on control mode. At step 620, the base controller 11 can execute in the add-on control mode.

### Application Fault Recovery Process

FIG. 6B provides a schematic diagram of a process 650 for restoring the application module 50 after occurrence of an application fault during operation of the HVAC field device 1.

At step 652, the application module experiences an application fault condition. The application fault condition can be an event that causes the application module 50 to fail, unexpectantly quit, experience sub-optimal performance, attempt to compromise operation of the core module 40, or another fault of the application module 50.

At step 654, the core module 40 can determine that the fault has occurred. The core module 40 may enter a fault restoration mode. The core module 40 can suspend execution of the application module without pausing operation of the core operating system or the functional device. The core module 40 may provide instructions to the base controller 11 to transition from add-on control mode to base control mode. In which case, at step 656, the base controller 11 can transition to the base control mode and execute control of the functional device. In the base control mode, the HVAC base block 10 can operate based on program code stored in the memory unit 16 of the base controller 11.

At step 658, the core module 40 can restore operation of the application module 50. The restoration of the application module 50 can be based on the type of fault that has been experienced. The core module 40 can have a defined process for addressing each type of fault. In some instances, the core module 40 can restart the application module 50, remove and reinstall the application module 50, revert the version of the application module 50 to a previous version, or perform other processes to restore operation of the application module 50.

At step 660, optionally, the core module 40 can provide a notification including fault data associated with the fault to one or more external devices. The notification can be sent based on the type of fault and any notification parameters. For example, some types of faults may result in a notification being sent to an HVAC control system. In some embodiments, the fault data could be stored in memory such as memory unit 26 or 4A. The fault data stored in memory 4A may be accessible via NFC through an external communication device 6.

At step 662, the restored application module 50 can be executed and can resume control of the operation of the functional device of the HVAC field device 1.

At step 664, the core module 40 can provide the process control data to the base controller 11 and can change the operation mode of the base controller 11 from the base control mode to the add-on control mode. At step 666, the base controller 11 can execute in the add-on control mode.

### Firmware and Core Module Update Process

FIG. 6C depicts steps of a block diagram illustrating an embodiment of a process 670 of updating the core module 40 and/or the firmware module 60 during operation of the HVAC field device 1.

At step 672, an external device 7 can provide a new or updated firmware module 60 and/or core module 40 to the HVAC field device 1. The external device 7 that provides the new/updated module(s) can be the HVAC control system or other type of computing device (e.g., communication device 6). The update to the firmware module 60 and/or the core module 40 can be communicated over a network, such as through communication interfaces 19, 23 of the HVAC base block 10 and HVAC add-on block 20, respectively.

At step 674, the core module 40 can schedule the update to the core module 40 or firmware module 60. For example, the core module 40 may have a scheduled time for applying updates. Prior to the update, the core module 40 can provide instructions to the base controller 11 to transition to the base control mode. In which case, at step 676, the base controller 11 can transition to the base control mode and execute control of the functional device 30. In the base control mode, the HVAC base block 10 can operate based on program code stored in the memory unit 16 of the base controller 11. The update to the core module 40 or firmware module 60 can be stored in intermediate non-volatile storage, such as on memory units 4A, 4B, 16, or 26.

At step 678, the add-on controller 21 can be rebooted. The reboot can be triggered by the core module 40 or the firmware module 60. At 680, the firmware module 60 can execute a secure boot process to establish the trusted execution environment. An immutable bootloader 61 can provide the root of trust for the secure boot process. The secure boot process can verify secure boot images for subsequent bootloaders, which can be cryptographically authenticated, such as by verifying signatures using public and private keys.

At step 682, the firmware module 60 can verify and update components of the firmware module 60. The bootloader module 61 can load new components of the firmware module 61 into the firmware partition 31 of the memory unit 26 and replace the previous versions. For example, one or more mutable bootloader stages may be replaced during the firmware update process. After any updates to the firmware module 60 are complete, the firmware module can establish a trusted execution environment.

If necessary, the firmware module 60 can load the new core module 40 into the core partition 28 of the memory unit 26. The firmware module 60 can authenticate and verify the new core module 40. In some instances, the update can be a replacement of the core module 40. In some instances, the update may be an updated version or updated modules of the core module 40. The core module 40 can operate in the core partition 28 of the memory unit 26 on the HVAC add-on block 20 and the firmware module 60 can operate in the firmware partition 31 of the memory unit 26. The firmware module 60 can execute the update without affecting the operation of HVAC base block 10. The update of the core module 40 can be confined to core partition 28 within the memory unit 26. For example, the firmware module 60 can start, shutdown, restart, update, remove, install, and/or otherwise control operation of the core module 40 as necessary to implement the update process. The update and restart of the core module 40 can be completed without performing a power reset of the HVAC field device 1. After the update is complete, the firmware module 60 can start execution of the core module 40.

At step 684, the firmware module 60 can determine that a fault has occurred. The firmware module 60 may enter a fail-safe recovery mode. At step 686, the firmware module 60 can restore operation of the core module 40. The firmware module 60 can roll back the version of the core module 40 to the previous version. The firmware module 60 can return to step 678 to reboot and restore the core module 40 to the previous version.

At step 688, the core module 40 can start the application module 50. At step 690, the HVAC module 52 can be executed and can resume control of the operation of the functional device 30 of the HVAC field device 1, such as described in step 602 of FIG. 6A.

At step 692, the core module 40 can provide the process control data to the base controller 11 and can change the operation mode of the base controller 11 from the base control mode to the add-on control mode. At step 694, the base controller 11 can execute in the add-on control mode.

### Operating HVAC Device

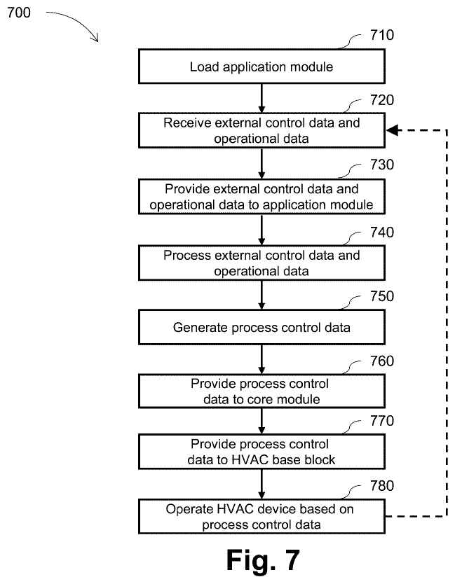

FIG. 7 depicts steps of an embodiment of a method 700 of operating an HVAC field device 1.

At step 710, the application module 50 is loaded into the application partition 29 of volatile memory of a memory unit 26 of the HVAC add-on block 20. The application module 50 is executed based on computer-executable instructions stored in the application partition 29 of non-volatile memory. The application module 50 is configured to provide functional control logic for controlling a functional device 30, such as an actuator and/or a sensor of the HVAC base block 10. The application module 50 may be provided to the HVAC add-on block 20 in a memory device internal or communicatively connected to the HVAC add-on block 20 (e.g., memory unit 26). Alternatively, or additionally, the application module 50 is provided to the HVAC add-on block 20 via the interface 23 of the HVAC add-on block 20 from external communication device(s) 6 and/or external device(s) 7. The application module 50 can be specific to the operating environment of the HVAC field device 1 (e.g., a house, office building, apartment, etc.). As another example, the application module 50 may be specific to operating conditions, such as operating in winter or summer. Each application can be specifically adapted to the combination of the HVAC add-on block 20 and HVAC base block 10. The application module 50 can be specific to the physical HVAC capabilities of the HVAC base block 10, such as actuating or sensing capabilities.

The application module 50 can be loaded by the core module 40 executing on the HVAC add-on block 20. The core module 40 can be a real-time operating system (RTOS) executing on a microprocessor of the HVAC add-on block 20, e.g., microprocessor 25. The core module 40 can be executed based on computer-executable instructions stored in core partition 28 of non-volatile memory. The core module 40 can execute in the core partition 28 of volatile memory. The application partition 29 and the core partition 28 can be isolated from each other by a memory manager 27.

At step 720, the core module 40 of the HVAC add-on block 20 receives external control data and operational data. The external control data can be received from an external server, such as the HVAC control system. The operational data can be received from the HVAC base block 10 based on operation of an HVAC functional device, such as a sensor or an actuator.

At step 730, the core module 40 can provide the external control data and operational data to the application module 50. The core module 40 and application module 50 can communicate between the core partition 28 and application partition 29 via an inter-thread API. The core module 40 can communicate at least a portion of the external control data and the operational data to the application module 50. The application module 50 is isolated by the memory manager 27 and is prevented from directly communicating with the HVAC base block 10 or external device(s) 7. This can prevent potential interference or faults caused by the application module 50 and improve the security and reliability.

At step 740, the application module 50 processes the external control data and operational data. The application module 50 can include logic and control algorithms that can be configured by process operational data (e.g., from HVAC the base block) and/or external control data (e.g., setpoints from an HVAC control system) and generate process control data for controlling the functional device of the HVAC base block 10. For example, the application module 50 can receive a current setpoint from an HVAC control system and use the setpoints to determine how the HVAC functional device will operate based on current operational data.

At step 750, the application module 50 can generate process control data. The application module 50 can use control logic and algorithms to generate process control data for controlling the functional device of the HVAC base block 10. The generation of the process control data can be based at least in part on the external process control signals, the operational data, configuration parameters, operational performance indicators, and/or other types of data.

At step 760, the application module 50 provides the process control data to the core module 40. The application module 50 can communicate with the core module 40 via an inter-thread API.

At step 770, the core module 40 can provide the process control data to the base controller 11 of the HVAC base block 10.

At step 780, the base controller 11 can operate the functional device based on the generated process control data. For example, the control signals can be used to adjust the position of an actuator. The process can then return to step 720 and repeat the control loop until an end condition occurs. For example, the HVAC control system can provide an instruction to stop the process, the process may stop when a temperature setpoint is achieved, or when another stop condition occurs.

### Process for Updating Application Module

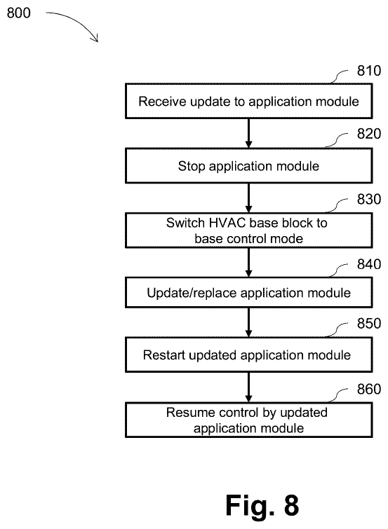

FIG. 8 illustrates an exemplary sequence of steps for a process 800 for updating an application module 50 during operation of an HVAC field device 1.

At step 810, the HVAC add-on block 20 receives an update to the application module 50 during operation of the HVAC field device 1. In other words, the update occurs after the HVAC field device 1 has been installed in the field. In some instances, the update can be a replacement of the application module 50 with a different application module 50. In some instances, the update may be an updated version of the application module 50. In some instances, the update is to one or more configuration parameters of the application module 50. The application module 50 update can be communicated over a network, such as through interface 23 of the add-on block 20 or interface 19 of the base block 10.

At step 820, the core module 40 can stop execution of the application module 50 during operation. The core module 40 can suspend execution of the application module 50 without pausing operation of the core module 40 or the functional device (e.g., an actuator or sensor) of the HVAC base block 10.

At step 830, the core module 40 can change the operation mode of the HVAC base block 10 from an add-on control mode to a base control mode. In the base control mode, the HVAC base block 10 can operate based on program code stored in the memory unit 16 of the base controller 11.

At step 840, the core module 40 can update/replace the application module 50 without pausing operation of the functional device (e.g., an actuator or sensor) of the HVAC base block 10. The update of the application module 50 can be confined to the second partition 29 within the memory unit 26.

At step 850, the updated application module 50 can be restarted. The update and restart of the application module 50 can be completed without performing a power reset, i.e. hard reset of the HVAC field device 1. This allows for the HVAC field device 1 to continue to operate during the update process.

At step 860, the core module 40 can change the operation mode of the HVAC base block 10 from the base control mode to the add-on control mode and the application module 50 can resume control.

### Process for Real-Time Fault Recovery

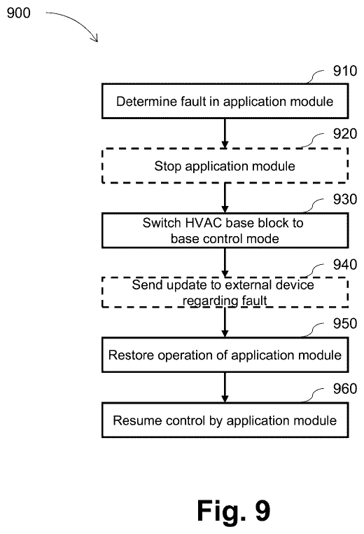

FIG. 9 illustrates an exemplary sequence of steps for a process 900 for restoring an application module 50 after a fault during operation of an HVAC field device 1.

At step 910, the core module 40 can determine that a fault occurred with the application module 50. The application module 50 can fail, unexpectantly quit, or experience a fault that causes the application module 50 to perform sub-optimally. The core module 40 can receive an indication that the fault has occurred. The core module 40 may enter a fault restoration mode.

At step 920, if necessary, the core module 40 can stop execution of the application module 50. The core module 40 can suspend execution of the application module 50 without pausing operation of the core module 40 or the functional device of the HVAC base block 10.

At step 930, the core module 40 can switch the operation mode of the HVAC base block 10 from add-on control mode to base control mode. In base control mode the base controller 11 can execute control of the functional device and control operation based on program code stored in the memory unit 16.

At step 940, optionally, the core module 40 can provide a notification to one or more external devices 7 associated with the fault. The notification can be sent based on the type of fault and any notification parameters. For example, some types of faults may result in a notification being sent to an HVAC control system.

At step 950, the core module 40 can restore operation of the application module 50. The restoration of the application module 50 can be based on the type of fault that has been experienced. The core module 40 can have a defined process for addressing each type of fault. In some instances, the core module 40 can restart the application module 50, remove and reinstall the application module 50, revert the version of the application module 50 to a previous version, or perform other processes to restore operation of the application module 50.

At step 960, the restored application module 50 can be executed and can resume control of the operation of the functional device of the HVAC field device 1.

### Process for Updating Firmware or Core Module

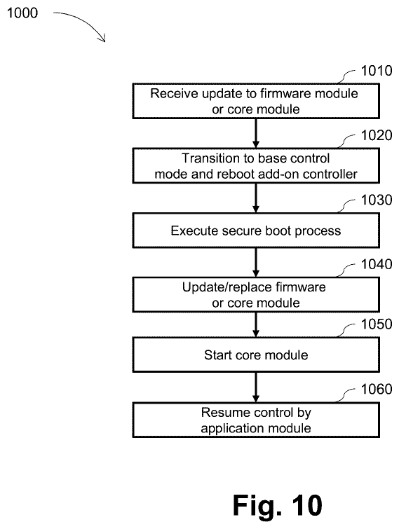

FIG. 10 illustrates an exemplary sequence of steps for a process 1000 for updating a firmware module 60 or core module 40 during operation of an HVAC field device 1.

At step 1010, the HVAC add-on block 20 receives an update to the firmware module 60 or core module 40 during operation of the HVAC field device 1. In other words, the update occurs after the HVAC field device 1 has been installed in the field. In some instances, the update can be a replacement of the core module 40 or firmware module 60 with a different core module 40 or firmware module 60, respectively. In some instances, the update may be an update to individual modules of the core module 40 or firmware module 60. The update to the firmware module 60 or core module 40 can be communicated over a network, such as through interface 23 of the add-on block 20 and/or interface 19 of the base block 10.

At step 1020, the core module 40 can change the operation mode of the HVAC base block 10 from an add-on control mode to a base control mode and reboot the add-on controller 21. The core module 40 can determine a time to update the core module 40 or firmware module 60. For example, the core module 40 may have a scheduled time for applying updates. Prior to the update, the core module 40 can provide instructions to the base controller 11 to transition to the base control mode. The reboot can then be triggered by the core module 40 or the firmware module 60.

At step 1030, the firmware module 60 can execute a secure boot process to establish the trusted execution environment. An immutable bootloader can provide the root of trust for the secure boot process. The secure boot process can verify secure boot images for subsequent bootloaders, which can be cryptographically authenticated, such as by verifying signatures using public and private keys.

At step 1040, the firmware module 60 can verify and update components of the firmware module 60. The bootloader module 61 can load new components of the firmware module 60 into the firmware partition 31 of the memory unit 26 and replace the previous versions. For example, one or more mutable bootloader stages may be replaced during the firmware update process. After any updates to the firmware module 60 are completed, the firmware module 60 can establish a trusted execution environment.

If necessary, the firmware module 60 can load the new core module 40 into the core partition 28 of the memory unit 26. The firmware module 60 can authenticate and verify the new core module 40. In some instances, the update can be a replacement of the core module 40. In some instances, the update may be an updated version or updated modules of the core module 40. The core module 40 can operate in the core partition 28 of the memory unit 26 on the HVAC add-on block 20 and the firmware module 60 can operate in the firmware partition 31 of the memory unit 26. The firmware module 60 can execute the update without affecting the operation of HVAC base block 10. The update of the core module 40 can be confined to core partition 28 within the memory unit 26. For example, the firmware module 60 can start, shutdown, restart, update, remove, install, and/or otherwise control operation of the core module 40 as necessary to implement the update process. The update and restart of the core module 40 can be completed without performing a power reset of the HVAC field device 1.

At step 1050, the firmware module 60 can start execution of the core module 40. The core module can resume control of the add-on block and resume operating system functionality.

At step 1060, the application module 50 can be started and resume control of the HVAC functional device. The core module 40 can change the operation mode of the HVAC base block 10 from the base control mode to the add-on control mode and the application module 50 can resume control.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-executable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

### First Set of Example Embodiments

Various example embodiments of the disclosure can be described by the following clauses:

Clause 1. An HVAC add-on block comprising: a housing; an extension interface configured to communicatively connect to an HVAC base block, wherein the HVAC base block comprises an HVAC functional device; a non-volatile memory unit comprising: a first set of computer-executable instructions stored in a first memory partition and configured to execute an operating system on the HVAC add-on block; and a second set of computer-executable instructions stored in a second memory partition and configured to execute an application module, wherein the application module is configured to control operation of the HVAC functional device communicatively coupled to the HVAC add-on block; a volatile memory unit; and at least one processor configured to: execute the operating system in a first memory region of the volatile memory unit and execute the application module in a second memory region of the volatile memory unit, wherein the application module is prevented from accessing the first memory region of the volatile memory unit.

Clause 2. The HVAC add-on block of clause 1, wherein the first set of computer-executable instructions are assigned a first memory region of the non-volatile memory unit and the second set of computer-executable instructions are assigned a second memory region of the non-volatile memory unit.

Clause 3. The HVAC add-on block of any of clauses 1 or 2, wherein the HVAC functional device comprises an actuator and/or a sensor.

Clause 4. The HVAC add-on block of clause 3, wherein the application module is configured to process actuator data and generate actuator control signals for operating an actuator of the HVAC base block.

Clause 5. The HVAC add-on block of clause 3, wherein the application module is configured to process sensor data and generate actuator control signals for operating an actuator of the HVAC base block.

Clause 6. The HVAC add-on block of any of clauses 1-5, wherein the operating system is configured to end execution of the application module and restart execution of the application module in response to detection of a fault during operation of the application module.

Clause 7. The HVAC add-on block of any of clauses 1-6, wherein the operating system is configured to update the application module to generate an updated application module without restarting operation of the HVAC add-on block.

Clause 8. The HVAC add-on block of clause 7, wherein the updated application module includes updated operational algorithms configured to control the HVAC functional device.

Clause 9. The HVAC add-on block of any of clauses 1-8, wherein the operating system is configured to load the application module into the second memory region of the volatile memory unit.

Clause 10. The HVAC add-on block of any of clauses 1-9, wherein the operating system and the application module are configured to communicate via an inter-thread application programming interface (API).

Clause 11. The HVAC add-on block of any of clauses 1-10 further comprising a memory protection unit (MPU) or memory management unit (MMU) configured to define memory regions and assign memory access permissions.

Clause 12. The HVAC add-on block of clause 11, wherein the MPU or MMU is configured such that all threads of the application module are only allowed access to the second memory region of the volatile memory unit.

Clause 13. The HVAC add-on block of any of clauses 1-12, wherein the operating system comprises a real-time operating system.

Clause 14. The HVAC add-on block of any of clauses 1-13, wherein the HVAC add-on block comprises a communication interface, the communication interface comprising a wired communication interface and/or a radio communication device.

Clause 15. The HVAC add-on block of clause 14, wherein the wired communication interface comprises at least one of an Ethernet, in particular a Power over Ethernet PoE, Single Pair Ethernet SPE, a BUS, in particular an MP Bus, BACnet, KNX or Modbus interface.

Clause 16. The HVAC add-on block of any of clauses 14-15, wherein the radio communication device comprises at least one of a wide area network communication circuit, a local area network communication circuit, a short-range wireless communication circuit or a close-range wireless communication circuit.

Clause 17. The HVAC add-on block of any of clauses 14-16, wherein the operating system is configured to receive an update to configuration parameters of the application module through the communication interface.

Clause 18. A computer-implemented method executed by at least one processor within an HVAC field device, the method comprising: providing, in a first partition of a non-volatile memory unit, a first set of computer-executable instructions configured to execute an operating system on the HVAC field device; providing, in a second partition of the non-volatile memory unit, a second set of computer-executable instructions configured to execute an application module configured to control operation of an HVAC functional device communicatively coupled to the HVAC field device; executing the first set of computer-executable instructions in a first memory region of a volatile memory unit; executing the second set of computer-executable instructions in a second memory region of the volatile memory unit, wherein the second set of computer-executable instructions is prevented from accessing the first memory region of the volatile memory unit; and operating the HVAC functional device based at least in part on the execution of the second set of computer-executable instructions.

Clause 19. Non-transitory computer storage media storing instructions that when executed by a system including at least one processor, cause the at least one processor to perform operations comprising: providing, in a first partition of a non-volatile memory unit, a first set of computer-executable instructions configured to execute an operating system on an HVAC field device; providing, in a second partition of the non-volatile memory unit, a second set of computer-executable instructions configured to execute an application module configured to control operation of an HVAC functional device communicatively coupled to the HVAC field device; executing the first set of computer-executable instructions in a first memory region of a volatile memory unit; executing the second set of computer-executable instructions in a second memory region of the volatile memory unit, wherein the second set of computer-executable instructions is prevented from accessing the first memory region of the volatile memory unit; and operating the HVAC functional device based at least in part on the execution of the second set of computer-executable instructions.

Clause 20. An HVAC field device comprising: a housing; an HVAC functional device; a non-volatile memory unit comprising: a first set of computer-executable instructions in a first memory partition configured to execute an operating system; and a second set of computer-executable instructions in a second memory partition configured to execute an application module, wherein the application module is configured to control operation of the HVAC functional device ; a volatile memory unit; and at least one processor configured to: execute the operating system in a first memory region of the volatile memory unit and execute the application module in a second memory region of the volatile memory unit, wherein the application module is prevented from accessing the first memory region of the volatile memory unit.

### Second Set of Example Embodiments

Various example embodiments of the disclosure can be described by the following clauses:

Clause 1. An HVAC add-on block comprising: a housing; an extension interface configured to communicatively connect to an HVAC base block, wherein the HVAC base block comprises an HVAC functional device; a non-volatile memory unit comprising: a secure memory partition comprising: a firmware module comprising computer-executable instructions on the HVAC add-on block; and a first non-secure memory partition comprising: a first set of computer-executable instructions configured to execute an operating system on the HVAC add-on block; and a second non-secure memory partition comprising: a second set of computer-executable instructions configured to execute an application module, wherein the application module is configured to control operation of the HVAC functional device communicatively coupled to the HVAC add-on block; a volatile memory unit; and at least one processor configured to execute the firmware module in a first secure memory region of the volatile memory unit, wherein the firmware module is configured to: execute a secure boot process in the first secure memory region of the volatile memory unit, wherein the secure boot process establishes a trusted execution environment; authenticate the operating system; and execute the authenticated operating system in a first non-secure memory region of the volatile memory unit, wherein the operating system is configured to execute the application module in a second non-secure memory region of the volatile memory unit.

Clause 2. The HVAC add-on block of clause 1, wherein the firmware module comprises at least one bootloader module comprising immutable computer-executable instructions, wherein the immutable computer-executable instructions provide a root of trust for the secure boot process.

Clause 3. The HVAC add-on block of clause 2, wherein the at least one bootloader module comprises a first stage bootloader that includes the immutable computer-executable instructions and a second stage bootloader comprising mutable computer-executable instructions, wherein the first stage bootloader is configured to authenticate the second stage bootloader and execute the authenticated second stage bootloader during the secure boot process.

Clause 4. The HVAC add-on block of any of clauses 1-3, wherein the operating system is configured to authenticate the application module prior to execution.

Clause 5. The HVAC add-on block of any of clauses 1-4, wherein the operating system and the firmware module are configured to communicate via a secure application programming interface (API).

Clause 6. The HVAC add-on block of any of clauses 1-5, wherein the HVAC add-on block further comprises a communication interface, the communication interface comprising a wired communication interface and/or a radio communication device.

Clause 7. The HVAC add-on block of clause 6, wherein the operating system is configured to receive an update to the operating system or the firmware module through the communication interface.

Clause 8. The HVAC add-on block of clause 7, wherein the firmware module is configured to update the operating system to generate an updated operating system during operation of the HVAC functional device.

Clause 9. The HVAC add-on block of clause 8, wherein the firmware module is configured to revert the updated operating system to a previous version of the operating system.

Clause 10. The HVAC add-on block of any of clauses 1-9, wherein the HVAC functional device comprises an actuator and/or a sensor.

Clause 11. An HVAC field device comprising: a housing; an HVAC functional device; a non-volatile memory unit comprising: a secure memory partition comprising: a firmware module comprising computer-executable instructions in a first secure memory partition; and a first non-secure memory partition comprising: a first set of computer-executable instructions configured to execute an operating system; and a second non-secure memory partition comprising: a second set of computer-executable instructions configured to execute an application module, wherein the application module is configured to control operation of the HVAC functional device; a volatile memory unit; and at least one processor configured to execute the firmware module in a first secure memory region of the volatile memory unit, wherein the firmware module is configured to: execute a secure boot process, wherein the secure boot process establishes a trusted execution environment in the first secure memory region of the volatile memory unit; authenticate the operating system; and execute the authenticated operating system in a first non-secure memory region of the volatile memory unit, wherein the operating system is configured to execute the application module in a second non-secure memory region of the volatile memory unit.

Clause 12. A computer-implemented method executed by at least one processor within an HVAC field device, the method comprising: providing a first set of computer-executable instructions, in a first secure partition of a non-volatile memory unit, configured to execute a firmware module; providing a second set of computer-executable instructions, in a first non-secure partition of the non-volatile memory unit, configured to execute an operating system; executing, by the firmware module, a secure boot process, wherein the secure boot process establishes a trusted execution environment in a first secure memory region of a volatile memory unit; authenticating, by the firmware module, the operating system; executing, by the firmware module, the authenticated operating system in a first non-secure memory region of the volatile memory unit; and executing, by the operating system, an application module in a second non-secure memory region of the volatile memory unit, wherein the application module is configured to control operation of an HVAC functional device of the HVAC field device.

Clause 13. The computer-implemented method of clause 12 further comprising receiving an update to the operating system or the firmware module through a communication interface.

Clause 14. The computer-implemented method of clause 13 further comprising updating the operating system to generate an updated operating system during operation of the HVAC functional device of the HVAC field device.

Clause 15. The computer-implemented method of clause 14 further comprising reverting the updated operating system to a previous version of the operating system.

Clause 16. The computer-implemented method of any of clauses 12-15, wherein the HVAC functional device comprises an actuator and/or a sensor.

Clause 17. The computer-implemented method of any of clauses 12-16, wherein the firmware module comprises at least one bootloader module comprising immutable computer-executable instructions, wherein the immutable computer-executable instructions provide a root of trust for the secure boot process.

Clause 18. The computer-implemented method of clause 17, wherein the at least one bootloader module comprises a first stage bootloader that includes the immutable computer-executable instructions and a second stage bootloader comprising mutable computer-executable instructions, wherein the method further comprising authenticating, by the first stage bootloader, the second stage bootloader and executing the authenticated second stage bootloader during the secure boot process.

What is claimed is:

1. An HVAC add-on block comprising:
a housing;
an extension interface configured to communicatively connect to an HVAC base block, wherein the HVAC base block comprises an HVAC functional device;
a non-volatile memory unit comprising:
a first set of computer-executable instructions stored in a first memory partition and configured to execute an operating system on the HVAC add-on block; and
a second set of computer-executable instructions stored in a second memory partition and configured to execute an application module, wherein the application module is configured to control operation of the HVAC functional device communicatively coupled to the HVAC add-on block;
a volatile memory unit; and
at least one processor configured to:
execute the operating system in a first memory region of the volatile memory unit and execute the application module in a second memory region of the volatile memory unit, wherein the application module is prevented from accessing the first memory region of the volatile memory unit.

2. The HVAC add-on block of claim 1, wherein the first set of computer-executable instructions are assigned a first memory region of the non-volatile memory unit and the second set of computer-executable instructions are assigned a second memory region of the non-volatile memory unit.

3. The HVAC add-on block of any of claims 1 or 2, wherein the HVAC functional device comprises an actuator and/or a sensor.

4. The HVAC add-on block of claim 3, wherein the application module is configured to process actuator data and generate actuator control signals for operating an actuator of the HVAC base block.

5. The HVAC add-on block of claim 3, wherein the application module is configured to process sensor data and generate actuator control signals for operating an actuator of the HVAC base block.

6. The HVAC add-on block of any of claims 1-5, wherein the operating system is configured to end execution of the application module and restart execution of the application module in response to detection of a fault during operation of the application module.

7. The HVAC add-on block of any of claims 1-6, wherein the operating system is configured to update the application module to generate an updated application module without restarting operation of the HVAC add-on block.

8. The HVAC add-on block of claim 7, wherein the updated application module includes updated operational algorithms configured to control the HVAC functional device.

9. The HVAC add-on block of any of claims 1-8, wherein the operating system is configured to load the application module into the second memory region of the volatile memory unit.

10. The HVAC add-on block of any of claims 1-9, wherein the operating system and the application module are configured to communicate via an inter-thread application programming interface (API).

11. The HVAC add-on block of any of claims 1-10 further comprising a memory protection unit (MPU) or memory management unit (MMU) configured to define memory regions and assign memory access permissions.

12. The HVAC add-on block of claim 11, wherein the MPU or MMU is configured such that all threads of the application module are only allowed access to the second memory region of the volatile memory unit.

13. The HVAC add-on block of any of claims 1-12, wherein the operating system comprises a real-time operating system.

14. The HVAC add-on block of any of claims 1-13, wherein the HVAC add-on block comprises a communication interface, the communication interface comprising a wired communication interface and/or a radio communication device.

15. The HVAC add-on block of claim 14, wherein the wired communication interface comprises at least one of an Ethernet, in particular a Power over Ethernet PoE, Single Pair Ethernet SPE, a BUS, in particular an MP Bus, BACnet, KNX or Modbus interface.

16. The HVAC add-on block of any of claims 14-15, wherein the radio communication device comprises at least one of a wide area network communication circuit, a local area network communication circuit, a short-range wireless communication circuit or a close-range wireless communication circuit.

17. The HVAC add-on block of any of claims 14-16, wherein the operating system is configured to receive an update to configuration parameters of the application module through the communication interface.

18. A computer-implemented method executed by at least one processor within an HVAC field device, the method comprising:
providing, in a first partition of a non-volatile memory unit, a first set of computer-executable instructions configured to execute an operating system on the HVAC field device;
providing, in a second partition of the non-volatile memory unit, a second set of computer-executable instructions configured to execute an application module configured to control operation of an HVAC functional device communicatively coupled to the HVAC field device;
executing the first set of computer-executable instructions in a first memory region of a volatile memory unit;
executing the second set of computer-executable instructions in a second memory region of the volatile memory unit, wherein the second set of computer-executable instructions is prevented from accessing the first memory region of the volatile memory unit; and
operating the HVAC functional device based at least in part on the execution of the second set of computer-executable instructions.

19. Non-transitory computer storage media storing instructions that when executed by a system including at least one processor, cause the at least one processor to perform operations comprising:
providing, in a first partition of a non-volatile memory unit, a first set of computer-executable instructions configured to execute an operating system on an HVAC field device;
providing, in a second partition of the non-volatile memory unit, a second set of computer-executable instructions configured to execute an application module configured to control operation of an HVAC functional device communicatively coupled to the HVAC field device;
executing the first set of computer-executable instructions in a first memory region of a volatile memory unit;
executing the second set of computer-executable instructions in a second memory region of the volatile memory unit, wherein the second set of computer-executable instructions is prevented from accessing the first memory region of the volatile memory unit; and
operating the HVAC functional device based at least in part on the execution of the second set of computer-executable instructions.

20. An HVAC field device comprising:
a housing;
an HVAC functional device;
a non-volatile memory unit comprising:
a first set of computer-executable instructions in a first memory partition configured to execute an operating system; and
a second set of computer-executable instructions in a second memory partition configured to execute an application module, wherein the application module is configured to control operation of the HVAC functional device ;
a volatile memory unit; and
at least one processor configured to:
execute the operating system in a first memory region of the volatile memory unit and execute the application module in a second memory region of the volatile memory unit, wherein the application module is prevented from accessing the first memory region of the volatile memory unit.
